(19) United States
(12) Patent Application Publication
(10) Pub. No.: US 2012/0021810 A1
(43) Pub. Date: Jan. 26, 2012

(54) Cell phone cover with pocket

(76) Inventor: Daniel Terry, Los Angeles, CA (US)

(21) Appl. No.: 12/804,405

(22) Filed: Jul. 20, 2010

(51) Int. Cl. H04M 1/00

(52) U.S. Cl. 455/575.8

(57) ABSTRACT

A Cell Phone Case with slit includes a cell phone cover. The cell phone cover comprises a vertical slit, an anterior end and a posterior end. In some preferred embodiments the cell phone cover may be made from neoprene, leather, canvas, or other materials.

### FIELD OF THE INVENTION

The present invention is in the area of cell phone accessories, and more particularly pertains to an article of manufacture for protecting cell phones and carrying cards.

### BACKGROUND OF THE INVENTION

The use of cell phones has exploded worldwide over the past twenty years. Today, nearly five billion people around the world own a cell phone. Moreover, the cell phone is increasingly replacing the traditional landline telephone as the primary means of communication. In fact, in the United States alone, one out of every four households has no landline but uses a cell phone as their phone source.

One of the problems which inheres with the use of some cell phones is that the exterior surface can abrade over time. Oftentimes, people place their cell phones in their pockets, purses, briefcases and bags where they rub against keys, loose change and whatever else there may be. These, resulting abrasions over time can render a cell phone unsightly and can damage the screen resolution.

Additionally, there are times when people just want to run an errand, go to the gym, or grab a drink at the bar or club and not want to have to worry about bringing their wallets, purses or bags. This often occurs when a person simply just doesn't want to be hauling their all their stuff around when all they really need is their phone, an i.d. card and a source of money-credit/debit card.

Therefore, what is clearly needed in the art is an article of manufacture which can protect the exterior surface of cell phones from surface abrasion and also securely hold carrying cards.

### SUMMARY OF THE INVENTION

It is an object of the present invention to provide an article of manufacture which can act as a carrying card holder while doubling as a cell phone cover. This is accomplished by creating a vertical or horizontal slit within the cell phone case or cover. The frictional force provided by the cell phone as the cell phone case presses the card(s) against it creates a fairly strong tolerance which can secure the card(s) enough so that they will not easily get jarred out of the cell phone case.

### BRIEF DESCRIPTION OF THE DRAWING FIGURES

FIG. 1 is a plan view of a preferred embodiment of the present invention.

FIG. 2 is a plan view of a preferred embodiment of the present invention.

FIG. 3 is a perspective view of a preferred embodiment of the present invention.

FIG. 4 is a plan view of a preferred embodiment of the present invention.

FIG. 5 is a plan view of a preferred embodiment of the present invention.

FIG. 6 is a plan view of a preferred embodiment of the present invention.

FIG. 7 is a plan view of a preferred embodiment of the present invention.

FIG. 8 is a perspective view of a preferred embodiment of the present invention.

FIG. 9 is a plan view of a preferred embodiment of the present invention.

FIG. 10 is a perspective view of a preferred embodiment of the present invention.

### DESCRIPTION OF PREFERRED EMBODIMENTS

According to a preferred embodiment of the present invention, a unique article of manufacture is used to protect the exterior of a cell phone and also provide a slit or pocket for carrying cards or other items. The present invention is described in enabling detail below.

For the purposes of the present invention, the term “pocket” shall be defined as a single slit, or cut into a cell phone case or covering to be able to accommodate the length of most carrying cards and other items. It should be understood that in some preferred embodiments, there may not be an extra membrane or covering disposed behind the slit because the cell phone itself can act as the frictional force member that keeps the credit cards or other items securely in place so that they will not easily become jarred out accidentally.

For the purposes of the present invention, the term “cell phone” shall further include other items such as “PDA's”, “smart phones”, or other devices which acts as a cell phone and/or also provides multiple functions through a computer chip. Moreover, for the purposes of the present invention, the terms “cell phone cover”, “cell phone case”, “cell phone protector”, shall be meant to be construed to be interchangeable. Furthermore, it is of no consequence if the cell phone is a clam shell, or just a flat PDA. The present invention is adaptable for use with a panoply of different cell phones.

Also, for the purposes of the present invention, it is understood that the cell phone case can be used to carry more than just credit cards, debit cards, i.d cards, drivers license or business cards. It can also be used to further include or carry spare car keys, cash, and other items of importance.

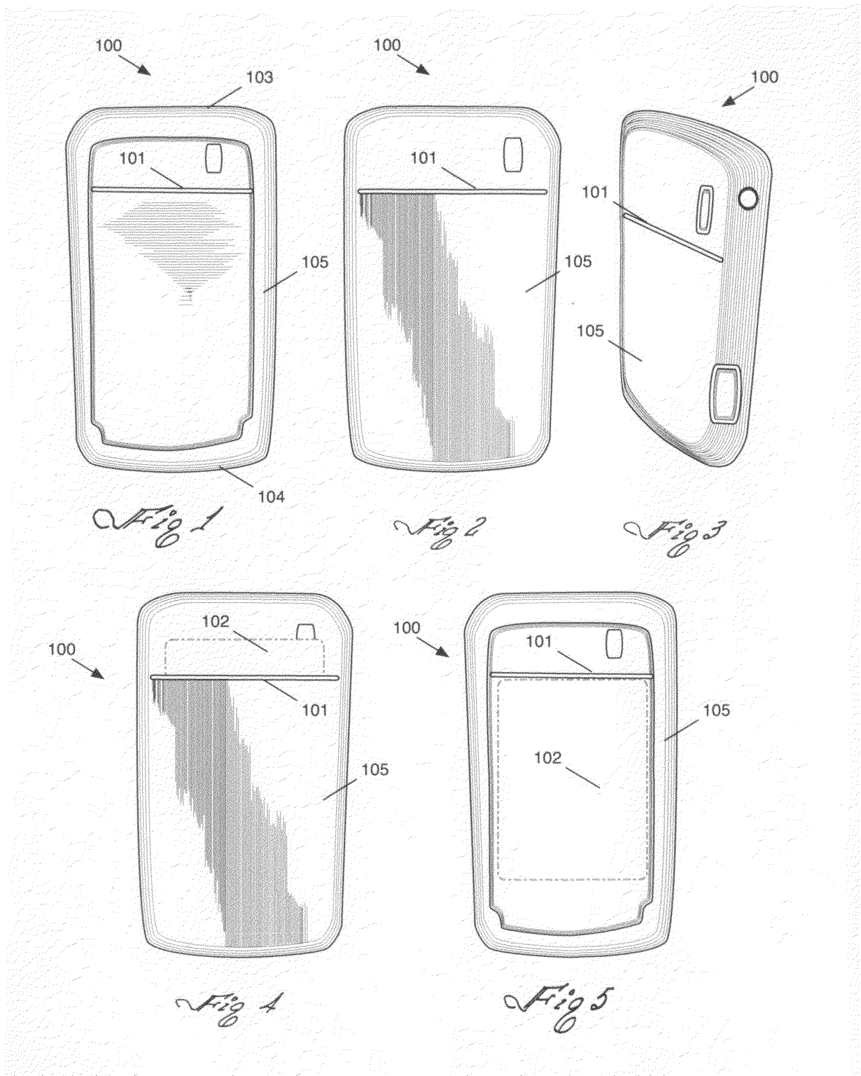

FIGS. 1-5 illustrate a preferred embodiment of the present invention. A Cell Phone Case with slit 100 includes a cell phone cover 105. The cell phone cover comprises a vertical slit 101, an anterior end 103 and a posterior end 104. In some preferred embodiments the cell phone cover may be made from neoprene, leather, canvas, or other materials. In some preferred embodiments, the slit may be polished or finished to smooth out the surface for a more polished and aesthetic look. It should be noted here that FIG. 1 illustrates a frontal side and FIG. 2 illustrates the rear view of the Cell Phone Case with slit 100. The front side of the Cell Phone Case with slit 100 is open such that a person can press the buttons and operate the phone. FIG. 9 illustrates how the phone is supposed to be placed within the Cell Phone Case with slit 100.

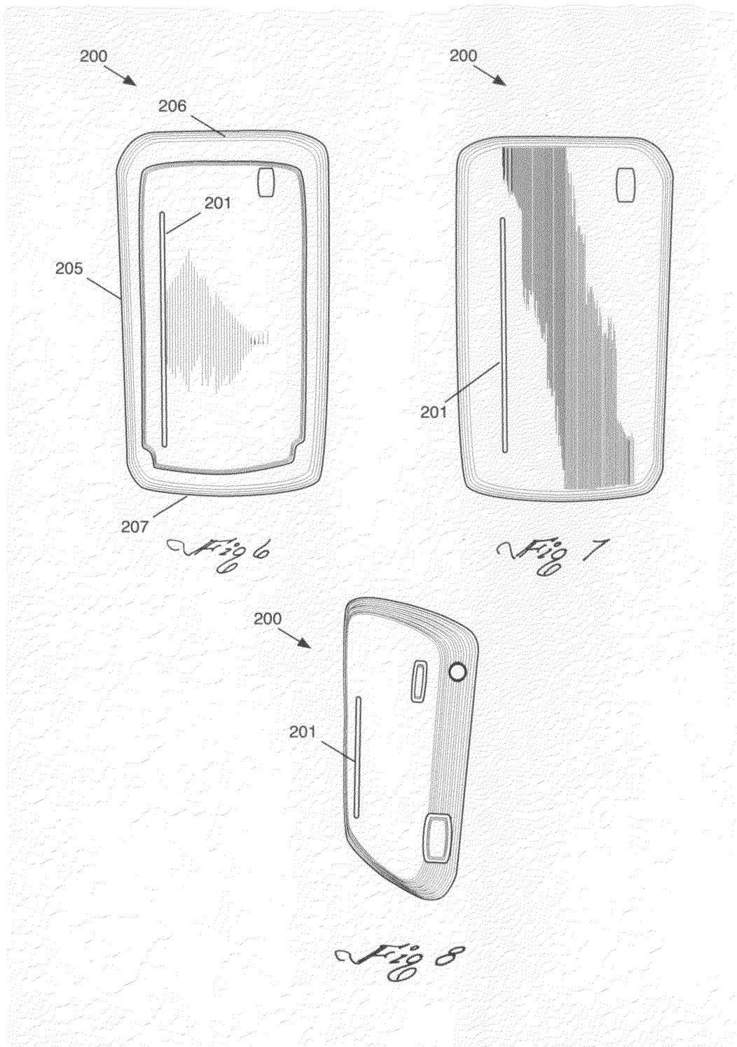

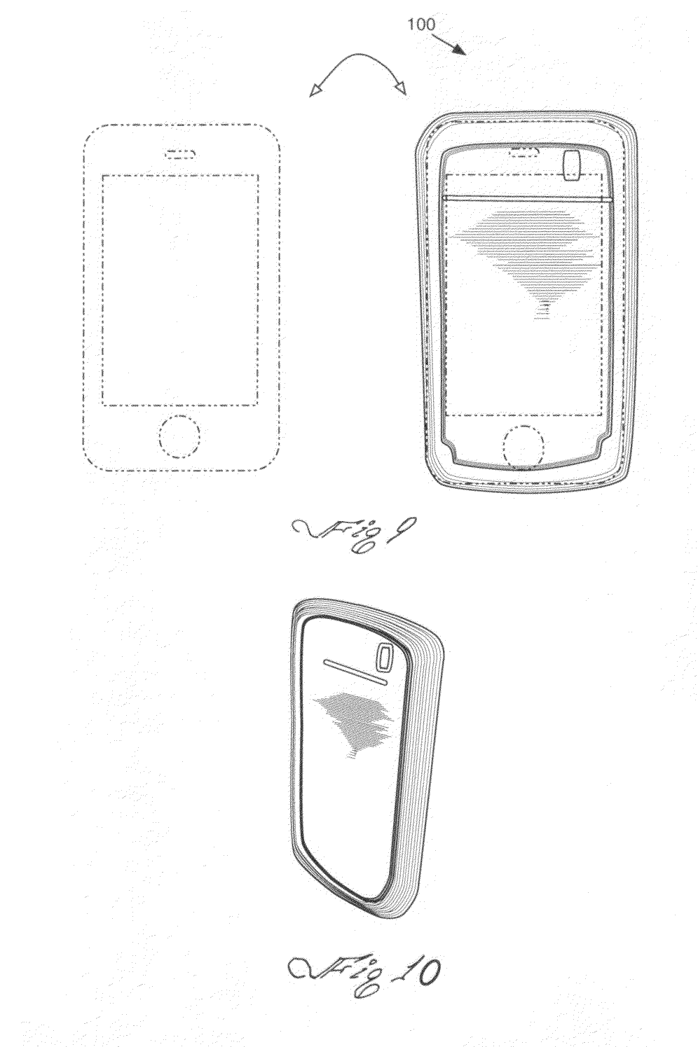

The vertical slit is disposed towards the anterior end. FIGS. 4-5 illustrate that a credit card, business card, or other items may be tarried away within the slit. The cell phone can act as the backing to secure those items within the slit so they will not easily fall out of the cell phone case.

The Horizontal Slit Cell Phone Case 200 comprising: a cell phone protector 205. The cell phone protector comprises a horizontal slit 201, a first end 206 and a second end 207. The horizontal slit is disposed towards the first end. The horizontal slit is sized to accommodate the length of most carrying cards.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Cell Phone Case with slit comprising:
a cell phone cover;
the cell phone cover comprises a vertical slit, an anterior end and a posterior end;
the vertical slit is disposed towards the anterior end.

2. The Horizontal Slit Cell Phone Case comprising: a cell phone protector; the cell phone protector comprises a horizontal slit, a first end and a second end; the horizontal slit is disposed towards the first end.
